(19) United States
(12) Patent Application Publication
(10) Pub. No.: US 2003/0167248 A1
(43) Pub. Date: Sep. 4, 2003

(54) Personal profiling system

(76) Inventor: Richard Silvano, Houston, TX (US)

Correspondence Address: HAYNES AND BOONE, LLP, 1000 LOUISIANA, SUITE 4300, HOUSTON, TX, 77002, US

(21) Appl. No.: 09/874,861

(22) Filed: Jun. 5, 2001

Related U.S. Application Data
(60) Provisional application No. 60/210,068, filed on Jun. 7, 2000.

(51) Int. Cl. G06N 5/02; G06F 17/00

(52) U.S. Cl. 706/48

(57) ABSTRACT

An personal profiling system. An interactive system for profiling an individual that provides a color coded profile. The user may then input an actual or desired job description and obtain a color coded profile of the job description. The user can then compare the color coded user profile with color coded profile of the job description in order to facilitate the selection or evaluation of the correlation between the user and job description profiles. More generally, the color coded user profile may be used to automatically select job descriptions from a database that are most appropriate for the user. More generally still, the color coded user profile may be used to automatically select descriptions from a database including, for example, product descriptions, advertisements, projects, descriptions of websites, etc . . . that are most appropriate for the user.

### CROSS-REFERENCE TO RELATED APPLICATIONS

This application claims the benefit of the filing date of U.S. provisional patent application serial No. 60/210,068, attorney docket number 23939.5, filed on Jun. 7, 2000, the disclosure of which is incorporated herein by reference

### COPYRIGHT NOTICE

A portion of the disclosure of this patent document contains material which is subject to copyright protection. The copyright owner has no objection to the facsimile reproduction by any one of the patent disclosure, as it appears in the Patent and Trademark Office patent files or records, but otherwise reserves all copyright rights whatsoever.

### CD-ROM APPENDIX (37 C.F.R. §1.96(c))

This application contains a CD-ROM Appendix containing a computer program listing.

### BACKGROUND

This invention relates generally to systems for providing a profile of an individual, and in particular to interactive systems for providing a profile of an individual.

Conventional systems for providing a profile of an individual typically provide a verbal description of a user's profile based upon a user's responses to a number of questions designed to elicit information representative of the user's profile. Such conventional systems suffer from a number of serious drawbacks. For example, such systems lack a simple and easy system of coded representations of the user profile thereby limiting the ease with which the results may be interpreted or compared with other profiles. Furthermore, such conventional systems are not implemented using an interactive system thereby limiting their efficiency and further application and use in providing the user with additional value added information. Finally, such conventional systems do not take into consideration empirical information regarding typical user profiles of the population at large that permit a more accurate and more efficient generation of the user profile.

The present invention is directed to overcoming one or more of the limitations of existing systems for generating user profiles.

### SUMMARY

According to one embodiment of the present invention, a computer implemented method of profiling a user is provided that includes the user selecting their interests, the user selecting their abilities, the user selecting their preferences, and generating a color coded profile of the user.

According to another embodiment of the present invention, a computer program for use in a system for profiling a user is provided that includes a storage medium, and program instructions recorded in the storage medium for: the user selecting their interests, the user selecting their abilities, the user selecting their preferences, and generating a color coded profile of the user.

According to another embodiment of the present invention, a system for generating a user profile is provided that includes a host computer, a network coupled to the host computer, and one or more users coupled to the host computer. The host computer is programmed to: permit the users to select their interests, permit the users to select their abilities, permit the users to select their preferences, and generate color coded profiles of the users.

According to another embodiment of the present invention, a system for generating a user profile is provided that includes means for the user selecting their interests, means for the user selecting their abilities; means for the user selecting their preferences, and means for generating a color coded profile of the user.

The present embodiments of the invention provide an interactive system for generating color coded user profiles. In this manner, an easily interpreted user profile is provided that can then be used to compare and search for job descriptions having color coded profiles. More generally, the color coded user profiles can be used to search for written descriptions of, for example, job descriptions, advertisements, web sites, and products in order to optimally match up such items with the user profile. In this manner, the creation and selection of items can be optimized to match up with the targeted users.

### BRIEF DESCRIPTION OF THE DRAWINGS

FIG. 1a is a schematic illustration of an embodiment of an interactive system for providing user profiles.

FIG. 1b is a schematic illustration of an embodiment of the web host of the system of FIG. 1a.

FIG. 2 is a flow chart illustration of an embodiment of a computer implemented method of generating user profiles for use in the system of FIG. 1.

FIG. 2a is an illustration of an embodiment of a screen display for selecting user interests.

FIG. 2b is an illustration of an embodiment of a screen display for selecting user abilities.

FIG. 2c is an illustration of an embodiment of a screen display for selecting user preferences.

FIG. 2d is an illustration of an embodiment of a screen display for displaying the color coded profile for the user.

FIG. 2e is an illustration of an embodiment of a screen display for inputting a job description.

FIG. 2ea is a schematic illustration of an embodiment of a database including red, blue, yellow, green, orange, purple, and brown word libraries that are used to generate a color coded profile of the job description.

FIG. 2f is an illustration of an embodiment of a screen display for displaying the color coded profile of the job description.

FIG. 2g is an illustration of an embodiment of a screen display for displaying the color coded profiles for the user and the job description.

FIG. 3a is a flow chart illustration of an embodiment of a method for generating color coded user profiles and searching one or more databases for matching job descriptions for use in the system of FIG. 1.

FIG. 3b is a schematic illustration of an embodiment of a database including color coded profiles for job descriptions and corresponding index values that correspond to the corresponding job descriptions.

FIG. 4a is a flow chart illustration of an embodiment of a method for generating color coded user profiles and searching one or more databases for items having matching color coded profiles.

FIG. 4b is a schematic illustration of an embodiment of a database including color coded profiles for other things and corresponding index values that correspond to the corresponding other things.

### DESCRIPTION OF THE PREFERRED EMBODIMENTS

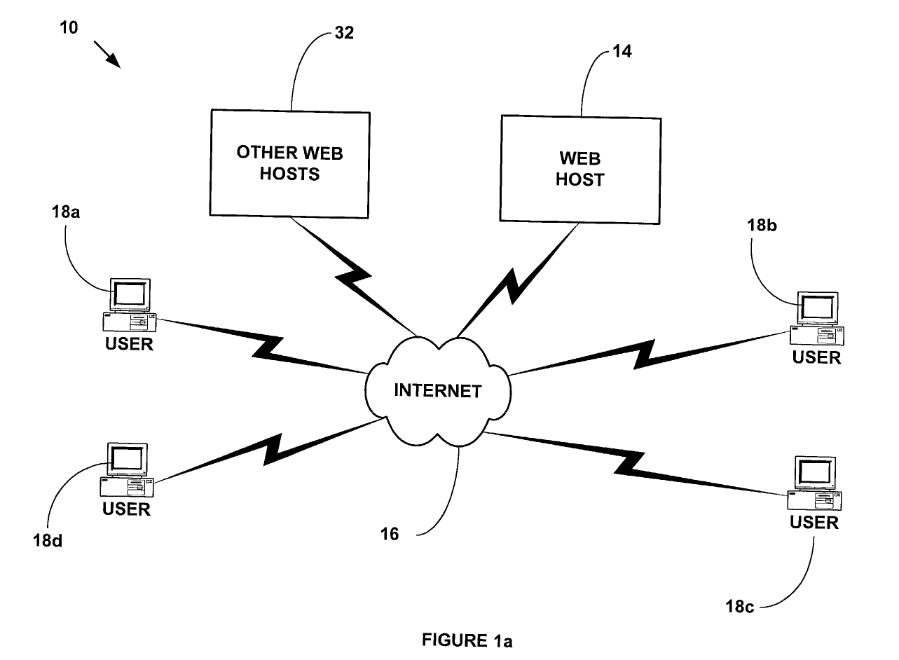

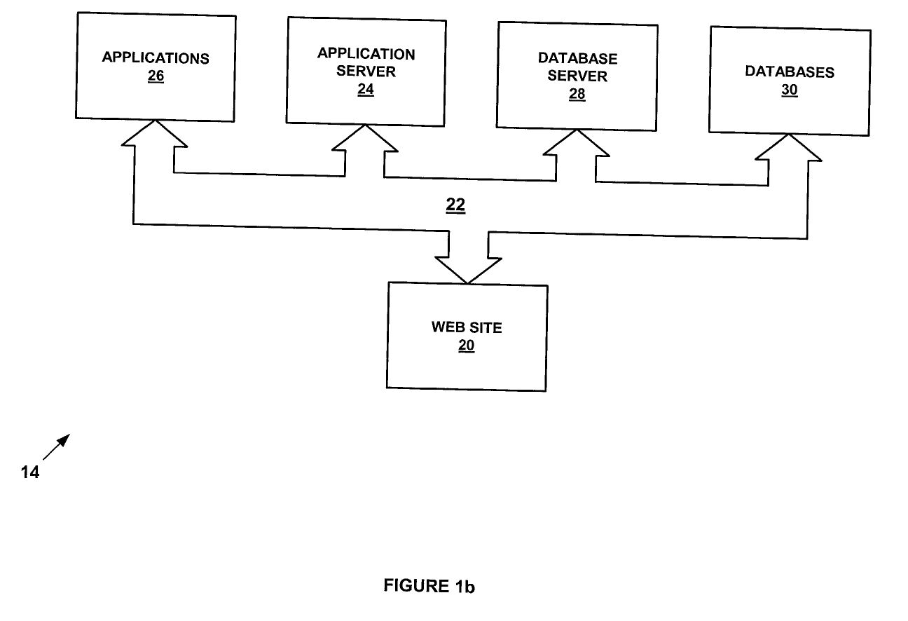

Referring to FIGS. 1a and 1b of the drawings, the reference numeral 10 refers, in general, to an interactive sales and marketing network system according to an embodiment of the invention that includes a web host 14 accessible using the Internet 16 that permits a plurality of users 18a-18d to generate color coded user profiles.

The web host 14 may include a website 20, a communication interface 22, an application server 24, one or more applications 26, a database server 28, and one or more databases 30. The general theory of operation of the website 20, communication interface 22, application server 24, and database server 28 are considered well known to persons having ordinary skill in the art. One or more other web hosts 32 having similar components to those provided in the web host 14 are also accessible via the Internet 16. As will be recognized by persons having ordinary skill in the art, the users 18 may access the web host 14 via the Internet 16 using, for example, a personal computer including a web browser and an internet service provider.

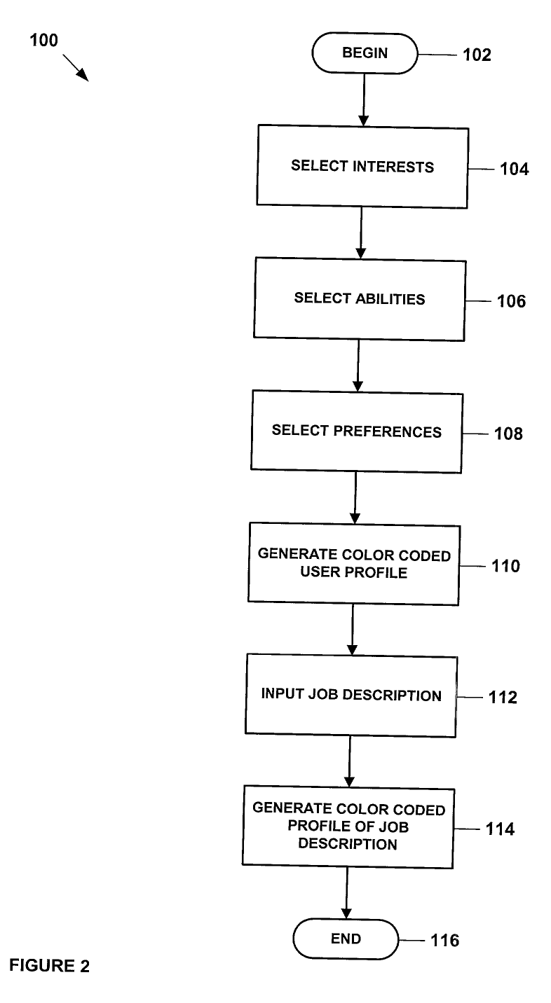

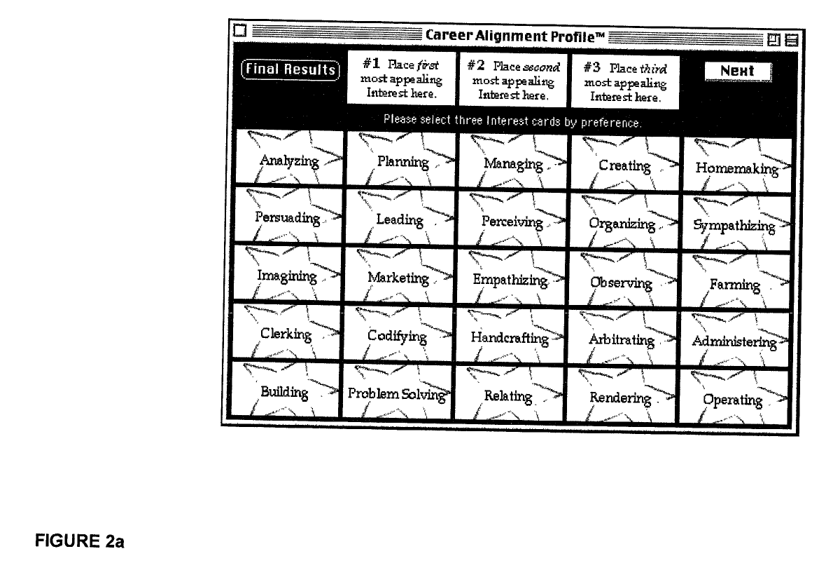

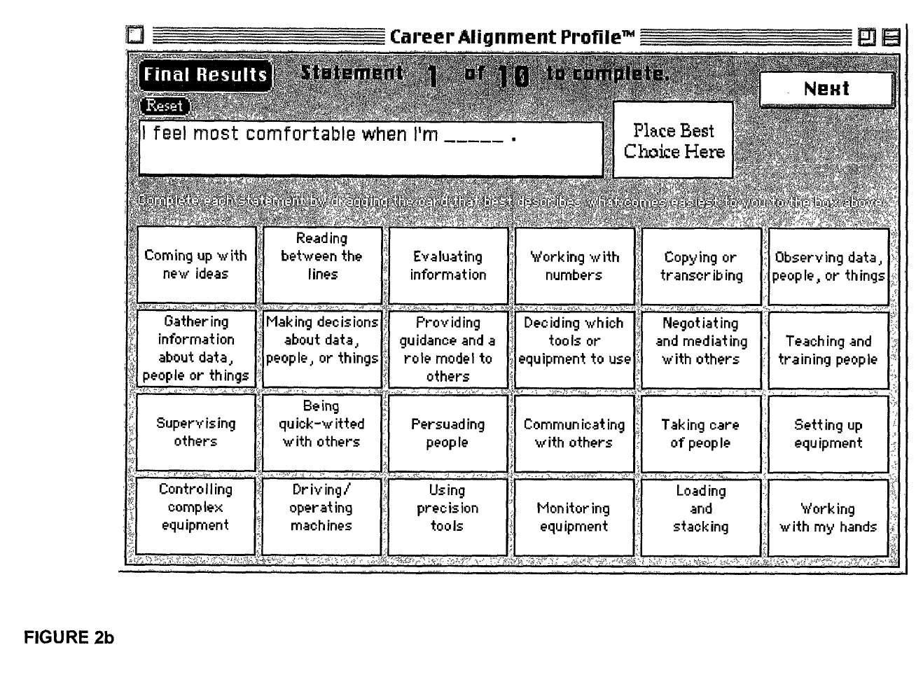

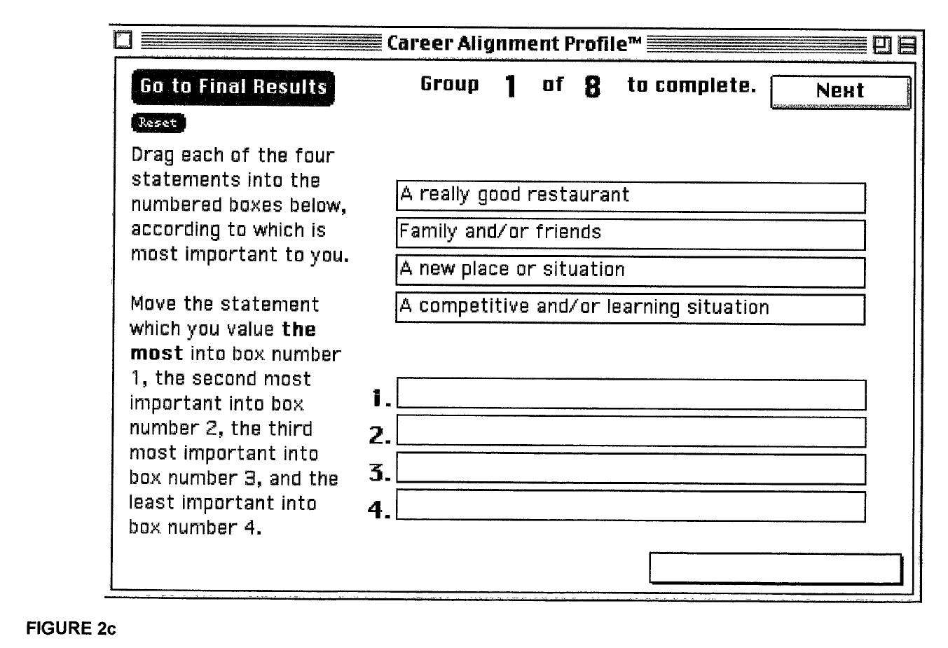

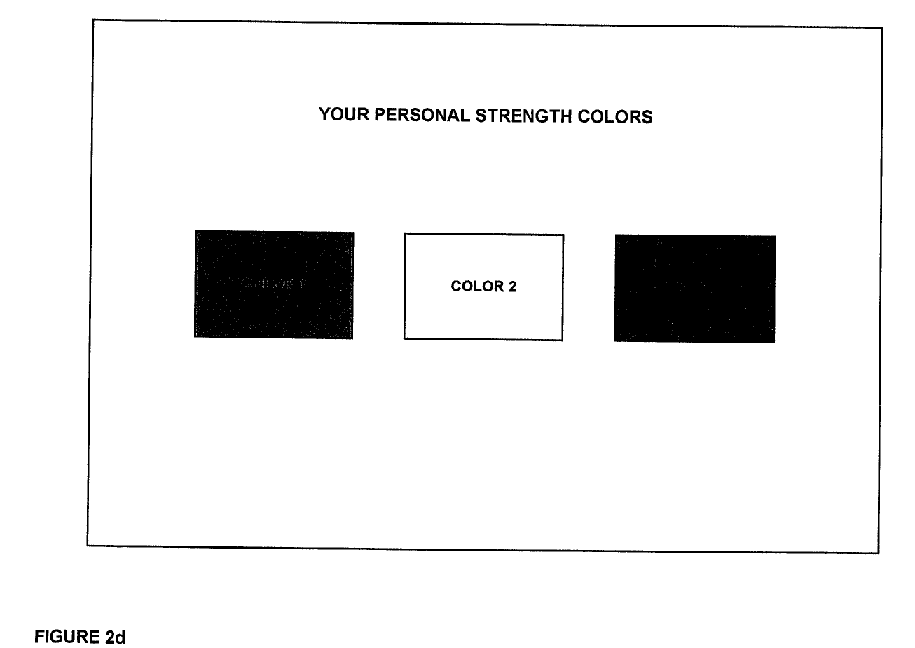

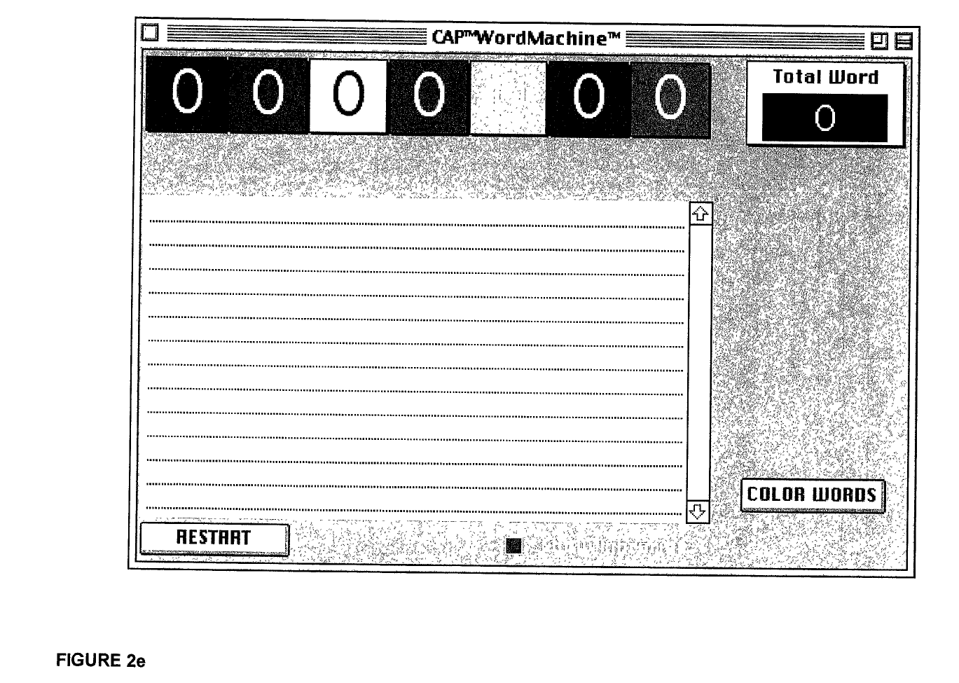

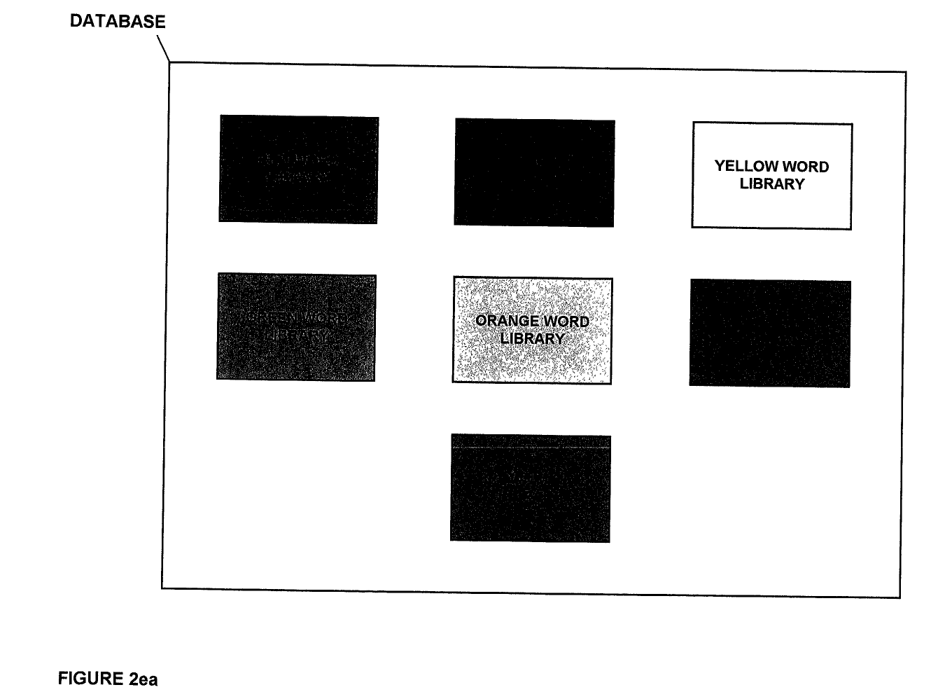

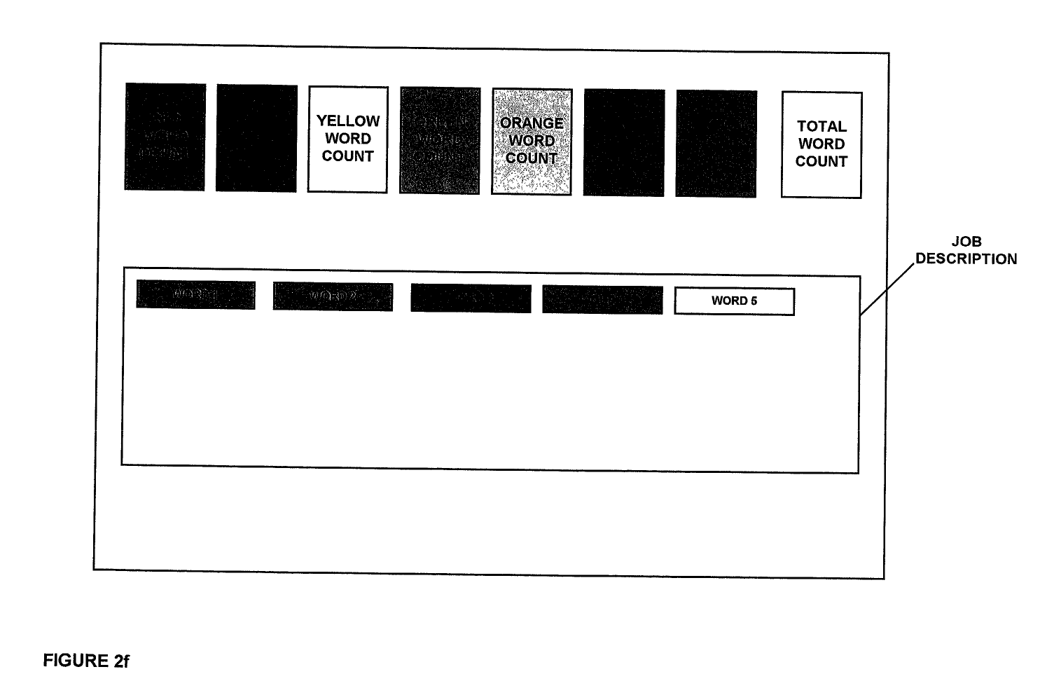

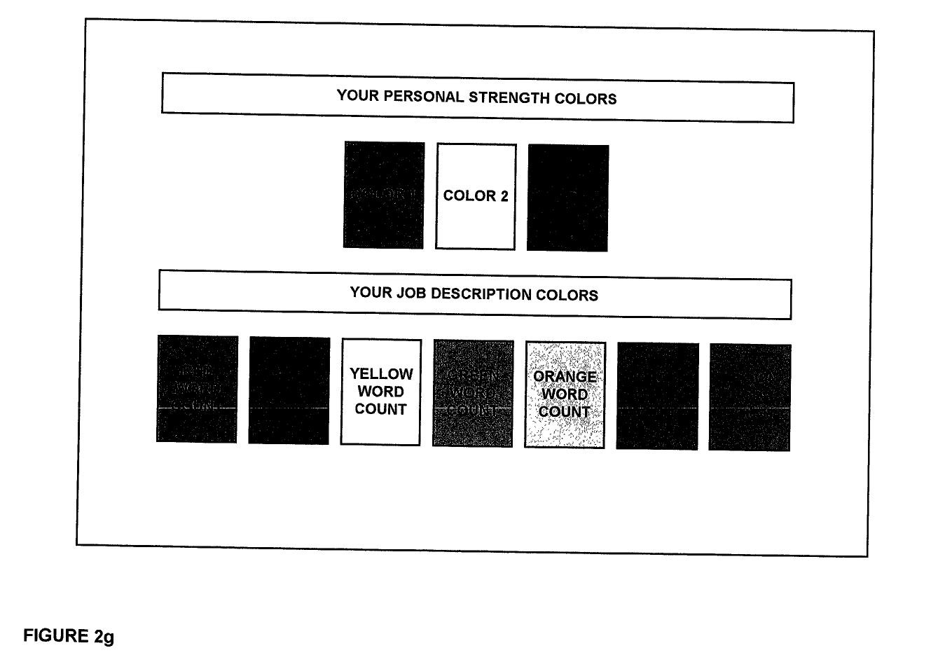

Referring to FIGS. 2, 2a, 2b, 2c, 2d, 2e, 2ea, 2f, and 2g, during operation of the system 10, a user 18 may interact with the web host 14 using a color coded user profile generation program 100 that is implemented by the web host 14 to generate a color coded user profile.

Initially, the user 18 begins in step 102 and may then select their interests in step 104. In an exemplary embodiment, in step 104, as illustrated in FIG. 2a, the user 18 selects the 3 most appealing interests from a group of 25 interests that include: (1) analyzing, (2) planning, (3) managing, (4) creating, (5) homemaking, (6) persuading, (7) leading, (8) perceiving, (9) organizing, (10) sympathizing, (11) imagining, (12) marketing, (13) empathizing, (14) observing, (15) farming, (16) clerking, (17) codifying, (18) handcrafting, (19) arbitrating, (20) administering, (21) building, (22) problem solving, (23) relating, (24) rendering, and (25) operating. In an exemplary embodiment, the selection is performed by clicking and dragging, in a conventional manner, the selected interests to the corresponding locations on the display.

In an exemplary embodiment, each of the 25 interests are assigned a color code that may, for example, include the primary colors: red, yellow, and blue, and the secondary colors: orange, green, purple or brown. In an exemplary embodiment, the color red corresponds to people that are analytical, the color yellow corresponds to people that are service oriented, and the color blue corresponds to people that are creative. The secondary colors of orange, green, purple, and brown correspond to combinations of the characteristics for the corresponding primary colors. For example, orange corresponds to combination of red and yellow characteristics, green corresponds to a combination of blue and yellow characteristics, purple corresponds to a combination of red and blue characteristics, and brown corresponds to a combination of red, yellow and blue characteristics. More generally, additional shades and hues may be defined in a corresponding manner. In this manner, user characteristics may be assigned a virtually infinite range of color coded values that may be easily compared and analyzed.

When the user 18 has completed their selection of the top 3 interests, then the user may proceed to step 106. In step 106, the user 18 may then select their abilities. In an exemplary embodiment, in step 106, as illustrated in FIG. 2b, the user 18 selects their abilities by completing a series of 10 sentences by clicking and dragging, in a conventional manner, the ability, from a group of 24 abilities, that best completes the sentence. In an exemplary embodiment, the 10 incomplete sentences include: (1) I feel most comfortable when I'm . . . ; (2) Time passes most quickly when I'm . . . ; (3) I do better at tasks when I am . . . ; (4) The tasks I seem to be best at emphasize . . . ; (5) I have been complimented by my supervisors due to my ability to . . . ; (6) I always knew I was good at . . . ; (7) When it comes right down to it, I'm best at . . . ; (8) I'm proud of my ability in . . . ; (9) . . . has always come naturally to me . . . ; and (10) I do well when I'm responsible for . . . In an exemplary embodiment, the 24 abilities include: (1) coming up with new ideas; (2) reading between the lines; (3) evaluating information; (4) working with numbers; (5) copying or transcribing; (6) observing data, people, or things; (7) gathering information about data, people or things; (8) making decisions about data, people or things; (9) providing guidance and a role model to others; (10) deciding which tools or equipment to use; (11) negotiating and mediating with others; (12) teaching and training people; (13) supervising others; (14) being quick-witted with others; (15) persuading people; (16) communicating with others; (17) taking care of people; (18) setting up equipment; (19) controlling complex equipment; (20) driving/operating machines; (21) using precision tools; (22) monitoring equipment; (23) loading and stacking; and (24) working with my hands.

In an exemplary embodiment, each of the 24 abilities are assigned a color code that may, for example, include the primary colors: red, yellow, and blue, and the secondary colors: orange, green, purple or brown. In an exemplary embodiment, the color red corresponds to people that are analytical, the color yellow corresponds to people that are service oriented, and the color blue corresponds to people that are creative. The secondary colors of orange, green, purple, and brown correspond to combinations of the characteristics for the corresponding primary colors. For example, orange corresponds to a combination of red and yellow characteristics, green corresponds to a combination of blue and yellow characteristics, purple corresponds to a combination of red and blue characteristics, and brown corresponds to a combination of red, yellow and blue characteristics. More generally, additional shades and hues may be defined in a corresponding manner. In this manner, user characteristics may be assigned a virtually infinite range of color coded values that may be easily compared and analyzed.

When the user 18 has completed their selection of abilities, then the user may proceed to step 108. In step 108, the user 18 may then select their preferences. In an exemplary embodiment, in step 108, as illustrated in FIG. 2c, the user 18 selects their preferences by ranking 32 statements, in groups of 4 statements, by clicking and dragging, in a conventional manner, the statements into the selected ranking position. For example, for each group of 4 statements, the user 18 ranks the 4 statements in the preferred order from 1^{st} to 4^{th}.

In an exemplary embodiment, the 1^{st} group of statements includes: (1) A really good restaurant; (2) Family and/or friends; (3) A new place or situation; and (4) A competitive and/or learning situation, the 2^{nd} group of statements includes: (1) A well structured company; (2) A people oriented company; (3) A creative company; and (4) A fast growing risk motivated company, the 3^{rd} group of statements includes: (1) A job or project that makes sense; (2) A job or project that benefits others; (3) a job or project that is different and exciting; and (4) A job or project that is mentally stimulating, the 4^{th} group of statements includes: (1) A good physical relationship; (2) A meaningful relationship; (3) New relationships; and (4) Challenging and/or competitive relationships, the 5^{th} group of statements includes: (1) Rewards based upon consistency; (2) Rewards based on loyalty; (3) Rewards based upon originality of ideas; and (4) Rewards based upon merit and achievement, the 6^{th} group of statements includes: (1) A familiar experience; (2) A moving emotional experience; (3) A new and different experience; and (4) A winning experience, the 7^{th} group of statements includes: (1) A task that one can see or touch; (2) A task that makes one feel good; (3) A task that calls upon one's imagination; and (4) A task that requires logical reasoning, and the 8^{th} group of statements includes: (1) Steady work; (2) Harmonious work; (3) Changing work; and (4) Efficient work.

In an exemplary embodiment, each of the 32 statements are assigned a color code that may, for example, include the primary colors: red, yellow, and blue, and the secondary colors: orange, green, purple or brown. In an exemplary embodiment, the color red corresponds to people that are analytical, the color yellow corresponds to people that are service oriented, and the color blue corresponds to people that are creative. The secondary colors of orange, green, purple, and brown correspond to combinations of the characteristics for the corresponding primary colors. For example, orange corresponds to a combination of red and yellow characteristics, green corresponds to a combination of blue and yellow characteristics, purple corresponds to a combination of red and blue characteristics, and brown corresponds to a combination of red, yellow and blue characteristics. More generally, additional shades and hues may be defined in a corresponding manner. In this manner, user characteristics may be assigned a virtually infinite range of color coded values that may be easily compared and analyzed.

When the user 18 has completed their selection of preferences, then the user may proceed to step 110. In step 110, the web host 14 may then generate a color coded profile for the user 18. In an exemplary embodiment, in step 110, as illustrated in FIG. 2d, the color coded user profile includes a display of the 3 personal strength colors for the user 18. In an exemplary embodiment, the web host 14 generates the 3 personal strength colors by implementing the computer software code provided in the CD-ROM Appendix.

After the generation of the color coded profile for the user 18, the user 18 may then input a job description in step 112. In an exemplary embodiment, as illustrated in FIG. 2e, the user 18 may type in a written description of a job using a keyboard. After inputting the job description, the user 18 may then request the web host 14 to generate a color coded profile of the job description by clicking on the COLOR WORDS button using a mouse.

In step 114, the web host 14 then may generate a color coded profile of the job description entered by the user 18 in step 112. In an exemplary embodiment, as illustrated in FIG. 2f, the color coded profile of the job description includes an indication of the numbers of words in the job description that are representative of red, blue, yellow, green, orange, purple, and brown characteristics, the total number of words, and the job description with the words that were coded displayed in the color code for the word. In this manner, the user 18 is provided with a color coded profile of the job description that is easy to analyze and compare with other color coded profiles.

In an exemplary embodiment, as illustrated in FIG. 2ea, the color coded profile of the job description is generated, at least in part, by comparing each word within the job description with a database including a red word library, a blue word library, a yellow word library, a green word library, an orange word library, a purple word library, and a brown word library. In this manner, those words in the job description that are found within a particular word library are then assigned the corresponding color code for that word library. In an exemplary embodiment, the color coded profile of the job description is generated by the web host 14 by implementing the computer software code provided in the CD-ROM Appendix.

As illustrated in FIG. 2g, the user 18 may then display the color coded user profile generated in step 110 with the color coded profile for the job description generated in step 114 on the same screen. In this manner, the user 18 may analyze and compare the color coded profiles to determine the degree to which the color coded profiles match up. In this manner, the user 18 may evaluate the suitability of the job description in view of the degree to which the color coded profiles correlate.

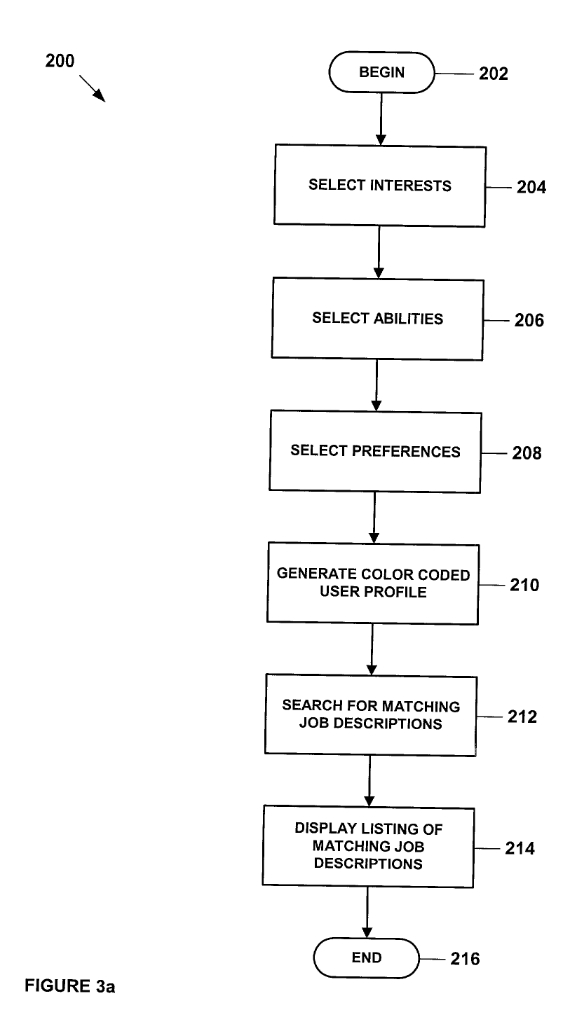

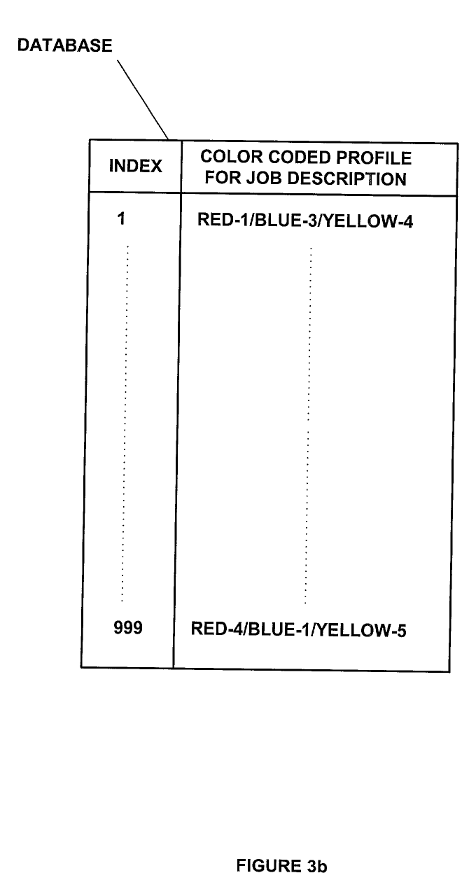

In an alternative embodiment, as illustrated in FIGS. 3a and 3b, during operation of the system 10, a user 18 may interact with the web host 14 using a color coded user profile generation and job search program 200 that is implemented by the web host 14 to generate a color coded user profile and then use that profile to search for job descriptions having color coded profiles that match the color coded user profile. In this manner, the user 18 may select jobs that are most suitable based upon the user profile. Steps 202, 204, 206, 208, and 210 of the program 200 are substantially identical to steps 102, 104, 106, 108, and 110, respectively, of the program 100.

In step 212, the user 18 may request the web host 14 to search for job descriptions having color coded profiles that match the color coded profile of the user 18. In an exemplary embodiment, the user 18 may select a tolerance upon the degree to which the color coded profiles must match. Alternatively, the web host 14 may use a default value for the tolerance during the search. The tolerance may range, for example, from a total match to a total mis-match. The search engine for implementing the search for job descriptions having color coded profiles that match the color coded profile of the user 18 in step 212 may be implemented in combination with any number of conventional Internet search engines such as, for example, those provided by Infoseek, Yahoo, Netscape, Alta Vista, GoTo, Lycos, MSN, and Excite.

In an exemplary embodiment, the job descriptions and/or the color coded profiles for the job descriptions may be stored in one or more of the databases 30 within the web host 14 and/or within one or more of the other web hosts 32. In an exemplary embodiment, the generation of the color coded profiles for the job descriptions are generated substantially as described in program step 114. The generation of the color coded profiles for the job descriptions may be done by batch processing a group of job descriptions and/or in real-time. The color coded profiles for the job descriptions may be generated by the web host 14, the other web hosts 32, and/or other computers. In an exemplary embodiment, as illustrated in FIG. 3b, the color coded profiles for the job descriptions are stored within a database including an index value that corresponds to the corresponding job description.

In step 214, the user 18 may request the web host 14 to provide a listing of the job descriptions having color coded profiles that match the color coded profile of the user 18. In this manner, the user 18 may then pursue employment opportunities with the employers that generated the job descriptions.

In several alternative embodiments, during operation of the program 200, the user 18 may generate a new color coded user profile or retrieve a saved color coded user profile for comparison with the color coded profile of the job description.

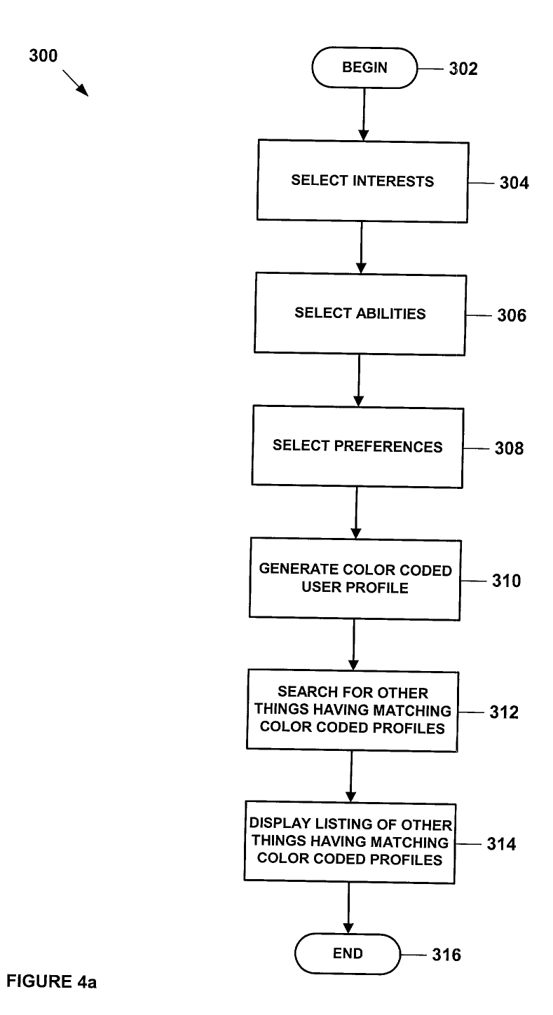

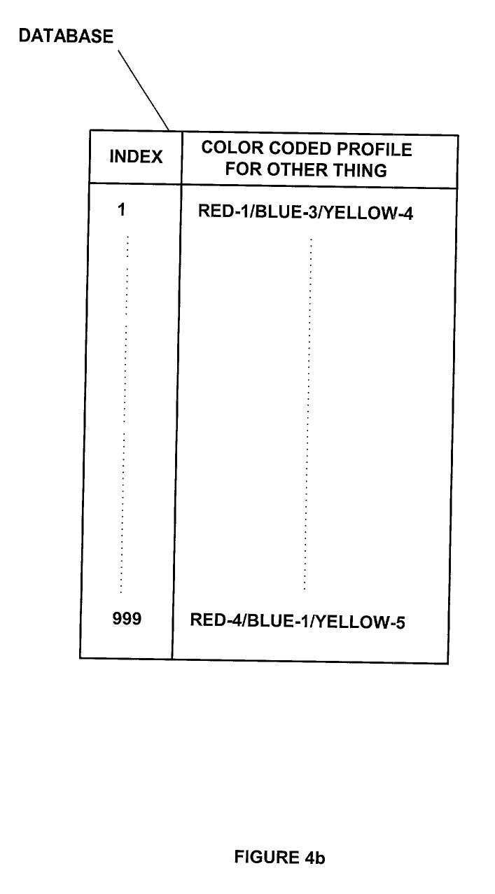

In an alternative embodiment, as illustrated in FIGS. 4a and 4b, during operation of the system 10, a user 18 may interact with the web host 14 using a color coded user profile generation and search program 300 that is implemented by the web host 14 to generate a color coded user profile and then use that profile to search for other things having color coded profiles that match the color coded user profile. The other things may include, for example, audio, video, photographs, other user profiles, products, and advertisements. In this manner, the user 18 may search for other things that have color coded profiles that match the color coded profile of the user. Steps 302, 304, 306, 308, and 310 of the program 300 are substantially identical to steps 102, 104, 106, 108, and 110, respectively, of the program 100.

In step 312, the user 18 may request the web host 14 to search for other things having color coded profiles that match the color coded profile of the user 18. In an exemplary embodiment, the user 18 may select a tolerance upon the degree to which the color coded profiles must match. Alternatively, the web host 14 may use a default value for the tolerance during the search. The tolerance may range, for example, from a total match to a total mis-match. The search engine for implementing the search for other things having color coded profiles that match the color coded profile of the user 18 in step 212 may be implemented in combination with any number of conventional Internet search engines such as, for example, those provided by Infoseek, Yahoo, Netscape, Alta Vista, GoTo, Lycos, MSN, and Excite.

In an exemplary embodiment, the other things and/or the color coded profiles for the other things may be stored in one or more of the databases 30 within the web host 14 and/or within one or more of the other web hosts 32. In an exemplary embodiment, the generation of the color coded profiles for the other things having textual information are generated substantially as described in program step 114. In an exemplary embodiment, the generation of the color coded profiles for other things having visual information are generated using a conventional vision system and the teachings of program step 114. In an exemplary embodiment, the generation of the color coded profiles for other things having audio information are generated using a conventional spectrum analyzer and the teachings of program step 114. In an exemplary embodiment, the generation of the color coded profiles for the other things having aromatic information are generated using a conventional aroma analyzer and the teachings of program step 114. In an exemplary embodiment, the generation of the color coded profiles for the other things having textual and/or audio and/or visual and/or aromatic information are generated using the teachings of program step 114 and a conventional vision system and/or a conventional spectrum analyzer and/or a conventional aroma analyzer.

The generation of the color coded profiles for the other things may be done by batch processing a group of other things and/or in real-time. The color coded profiles for the other things may be generated by the web host 14, the other web hosts 32, or other computers. In an exemplary embodiment, as illustrated in FIG. 4b, the color coded profiles for the other things are stored within a database including an index value that corresponds to the corresponding other thing.

In step 314, the user 18 may request the web host 14 to provide a listing of the other things having color coded profiles that match the color coded profile of the user 18. In this manner, the user 18 may then further investigate and review the other things.

In several alternative embodiments, during operation of the program 300, the user 18 may generate a new color coded user profile or retrieve a saved col or coded user profile for comparison with the color coded profile of the other things.

In an exemplary embodiment, the design and operation of the system 10 is provided and implemented utilizing the computer program contained in the CD-ROM Appendix to the present application.

The personal profiling system provides several advantages. For example, the use of a color coded user profile provides an easy to use metric for analyzing and comparing the user profile with other color coded profiles. In this manner, the teachings of the present disclosure may be used to permit the optimal selection of jobs, products, advertisements, multimedia, and other things having color coded profiles that match up with the color coded profile of the user.

It is understood that variations may be made in the foregoing without departing from the scope of the invention. For example, the teachings of the present disclosure can be used in a stand alone computer, a local area network, a wide area network, or the Internet. Furthermore, the color coded profiles of the users and/or the job descriptions and/or the other things may be manually generated.

Although illustrative embodiments of the invention have been shown and described, a wide range of modification, changes and substitution is contemplated in the foregoing disclosure. In some instances, some features of the present invention may be employed without a corresponding use of the other features. Accordingly, it is appropriate that the appended claims be construed broadly and in a manner consistent with the scope of the invention.

What is claimed is:

1. A computer implemented method of profiling a user, comprising:
the user selecting their interests;
the user selecting their abilities;
the user selecting their preferences; and
generating a color coded profile of the user.

2. The method of claim 1, further including:
the user inputting a job description; and
generating a color coded profile of the job description.

3. The method of claim 2, further including:
determining the degree to which the color coded profile of the user matches with the color coded profile of the job description.

4. The method of claim 1, further including:
searching for job descriptions having color coded profiles that match up with the color coded profile of the user.

5. The method of claim 4, further including:
the user selecting the degree to which the color coded profiles of the job descriptions must match up with the color coded profile of the user.

6. The method of claim 1, further including:
searching for other things having color coded profiles that match up with the color coded profile of the user.

7. The method of claim 6, wherein the other things comprise textual information.

8. The method of claim 6, wherein the other things comprise visual information.

9. The method of claim 6, wherein the other things comprise audio information.

10. The method of claim 6, wherein the other things comprise aromatic information.

11. The method of claim 6, further including:
the user selecting the degree to which the color coded profiles of the other things must match with up the color coded profile of the user.

12. A computer program, comprising:
a storage medium;
program instructions recorded in the storage medium for:
the user selecting their interests;
the user selecting their abilities;
the user selecting their preferences; and
generating a color coded profile of the user.

13. The computer program of claim 12, further including program instructions for:
the user inputting a job description; and
generating a color coded profile of the job description.

14. The computer program of claim 13, further including program instructions for:
determining the degree to which the color coded profile of the user matches with the color coded profile of the job description.

15. The computer program of claim 12, further including program instructions for:
searching for job descriptions having color coded profiles that match up with the color coded profile of the user.

16. The computer program of claim 15, further including program instructions for:
the user selecting the degree to which the color coded profiles of the job descriptions must match up with the color coded profile of the user.

17. The computer program of claim 12, further including program instructions for:
searching for other things having color coded profiles that match up with the color coded profile of the user.

18. The computer program of claim 17, wherein the other things comprise textual information.

19. The computer program of claim 17, wherein the other things comprise visual information.

20. The computer program of claim 17, wherein the other things comprise audio information.

21. The computer program of claim 17, wherein the other things comprise aromatic information.

22. The computer program of claim 17, further including program instructions for:
the user selecting the degree to which the color coded profiles of the other things must match with up the color coded profile of the user.

23. A system for generating a user profile, comprising:
a host computer;
a network coupled to the host computer; and
one or more users coupled to the host computer;
wherein the host computer is programmed to:
permit the users to select their interests;
permit the users to select their abilities;
permit the users to select their preferences; and
generate color coded profiles of the users.

24. The system of claim 23, wherein the host computer is further programmed to:
permit the users to input a job description; and
generate color coded profiles of the job descriptions.

25. The system of claim 24, wherein the host computer is further programmed to:
determine the degree to which the color coded profiles of the users matches with the color coded profile of the job descriptions.

26. The system of claim 23, further including:
a database operably coupled to the host computer; and
wherein the host computer is further programmed to:
search for job descriptions within the database having color coded profiles that match up with the color coded profiles of the users.

27. The system of claim 26, wherein the host computer is further programmed to permit the users to select the degree to which the color coded profiles of the job descriptions must match up with the color coded profiles of the users.

28. The system of claim 23, further including:
a database operably coupled to the host computer; and
wherein the host computer is further programmed to search for other things within the database having color coded profiles that match up with the color coded profiles of the users.

29. The system of claim 23, wherein the other things comprise textual information.

30. The system of claim 23, wherein the other things comprise visual information.

31. The system of claim 23, wherein the other things comprise audio information.

32. The system of claim 23, wherein the other things comprise aromatic information.

33. The system of claim 23, wherein the host computer is further programmed to permit the users to select the degree to which the color coded profiles of the other things must match with up the color coded profiles of the users.

34. A system for generating a user profile, comprising:
means for the user selecting their interests;
means for the user selecting their abilities;
means for the user selecting their preferences; and
means for generating a color coded profile of the user.

35. The system of claim 34, further including:
means for the user inputting a job description; and
means for generating a color coded profile of the job description.

36. The system of claim 35, further including:
means for determining the degree to which the color coded profile of the user matches with the color coded profile of the job description.

37. The system of claim 34, further including:
means for searching for job descriptions having color coded profiles that match up with the color coded profile of the user.

38. The system of claim 37, further including:
means for the user selecting the degree to which the color coded profiles of the job descriptions must match up with the color coded profile of the user.

39. The system of claim 34, further including:
means for searching for other things having color coded profiles that match up with the color coded profile of the user.

40. The system of claim 39, wherein the other things comprise textual information.

41. The system of claim 39, wherein the other things comprise visual information.

42. The system of claim 39, wherein the other things comprise audio information.

43. The system of claim 39, wherein the other things comprise aromatic information.

44. The system of claim 39, further including:
means for the user selecting the degree to which the color coded profiles of the other things must match with up the color coded profile of the user.

45. A computer implemented method of profiling a user, comprising:
the user selecting their interests;
the user selecting their abilities;
the user selecting their preferences;
generating a color coded profile of the user;
the user inputting a job description;
generating a color coded profile of the job description;
determining the degree to which the color coded profile of the user matches with the color coded profile of the job description;
searching for job descriptions having color coded profiles that match up with the color coded profile of the user;
the user selecting the degree to which the color coded profiles of the job descriptions must match up with the color coded profile of the user;
searching for other things having color coded profiles that match up with the color coded profile of the user; and
the user selecting the degree to which the color coded profiles of the other things must match with up the color coded profile of the user.

46. A computer program, comprising:
a storage medium;
program instructions recorded in the storage medium for:
the user selecting their interests;
the user selecting their abilities;
the user selecting their preferences;
generating a color coded profile of the user;
the user inputting a job description;
generating a color coded profile of the job description;
determining the degree to which the color coded profile of the user matches with the color coded profile of the job description;
searching for job descriptions having color coded profiles that match up with the color coded profile of the user;
the user selecting the degree to which the color coded profiles of the job descriptions must match up with the color coded profile of the user;
searching for other things having color coded profiles that match up with the color coded profile of the user; and
the user selecting the degree to which the color coded profiles of the other things must match with up the color coded profile of the user.

47. A system for generating a user profile, comprising:
a host computer;
a database coupled to the host computer;
a network coupled to the host computer; and
one or more users coupled to the host computer;
wherein the host computer is programmed to:
permit the user to select their interests;
permit the user to select their abilities;
permit the user to select their preferences;
generate a color coded profile of the user;
permit the user to input a job description;
generate a color coded profile of the job description;
determine the degree to which the color coded profile of the user matches with the color coded profile of the job description;
search for job descriptions within the database having color coded profiles that match up with the color coded profile of the user;
permit the user to select the degree to which the color coded profiles of the job descriptions must match up with the color coded profile of the user;
search for other things within the database having color coded profiles that match up with the color coded profile of the user; and
permit the user to select the degree to which the color coded profiles of the other things must match with up the color coded profile of the user

48. A system for generating a profile of a user, comprising:
means for the user selecting their interests;
means for the user selecting their abilities;
means for the user selecting their preferences;
means for generating a color coded profile of the user;
means for the user inputting a job description;
means for generating a color coded profile of the job description;
means for determining the degree to which the color coded profile of the user matches with the color coded profile of the job description;
means for searching for job descriptions having color coded profiles that match up with the color coded profile of the user;
means for the user selecting the degree to which the color coded profiles of the job descriptions must match up with the color coded profile of the user;
means for searching for other things having color coded profiles that match up with the color coded profile of the user; and
means for the user selecting the degree to which the color coded profiles of the other things must match with up the color coded profile of the user.
